(19) United States
(12) Patent Application Publication
(10) Pub. No.: US 2023/0297880 A1
(43) Pub. Date: Sep. 21, 2023

(54) COGNITIVE ADVISORY AGENT

(71) Applicant: International Business Machines Corporation, Armonk, NY (US)

(72) Inventors: Shubhi Asthana, Santa Clara, CA (US); Shikhar Kwatra, San Jose, CA (US)

(21) Appl. No.: 17/699,222

(22) Filed: Mar. 21, 2022

(51) Int. Cl. G06N 20/00; G06F 40/279

(52) U.S. Cl. CPC G06N 20/00; G06F 40/279

(57) ABSTRACT

A computer implemented method includes receiving a dataset for use with respect to a current machine learning model, wherein the dataset comprises one or more features, analyzing one or more external datasets to identify a set of similar features, appending the similar features to the received dataset to generate an updated dataset, applying the updated dataset to the current machine learning model to generate an updated machine learning model, and assessing performance of the updated machine learning model. The method may further include categorizing the features of the dataset into categorical text features and unstructured text features. The method may additionally include recommending one or more actions based on the performance assessment of the updated machine learning model. The method may further include converting the one or more features into numerical feature vectors and identifying a vectoral distance between the one or more features and the set of similar features.

### STATEMENT REGARDING PRIOR DISCLOSURES BY THE INVENTOR OR A JOINT INVENTOR

The following disclosure is submitted under 35 U.S.C. 102(b)(1)(A):

### Disclosure

“Cognitive Advisory Agent”, S. Asthana and S. Kwatra, 2021 IEEE International Conference on Smart Data Services (SMDS), Sep. 5-10, 2021, DOI 10.1109/SMDS53860.2021.00017, pages 52-54.

### BACKGROUND

The present invention relates generally to the field of machine learning, and more specifically to updating datasets to inform machine learning models.

Machine learning is a method of data analysis that automates analytical model building. It is a branch of artificial intelligence based on the idea that systems can learn from data, identify patterns, and make decisions with minimal human intervention. Machine learning algorithms often build a model based on sample data, known as training data, in order to make predictions or decisions without being explicitly programmed to do so. Machine learning algorithms are used in a wide variety of applications, especially those where it is difficult or unfeasible to develop conventional algorithms to perform the needed tasks. In an increasingly data-driven world, data engineers gain insight by combining data from different sources. A common machine learning workflow includes extracting data from a data lake or data warehouse, training a model on historic user behavior, predicting future user behaviors according to the model and more recent data, and saving the results to a data warehouse or application database.

### SUMMARY

As disclosed herein, a computer implemented method includes receiving a dataset for use with respect to a current machine learning model, wherein the dataset comprises one or more features, analyzing one or more external datasets to identify a set of similar features, appending the similar features to the received dataset to generate an updated dataset, applying the updated dataset to the current machine learning model to generate an updated machine learning model, and assessing performance of the updated machine learning model. The method may additionally include recommending one or more actions based on the performance assessment of the updated machine learning model. A computer program product and computer system corresponding to the method are also disclosed.

### BRIEF DESCRIPTION OF THE DRAWINGS

FIG. 1 is a block diagram depicting a cognitive advising system in accordance with an embodiment of the present invention;

FIG. 2 is a flowchart depicting a model updating method in accordance with an embodiment of the present invention;

FIG. 3 is a flowchart depicting a cognitive advising method in accordance with an embodiment of the present invention; and

FIG. 4 is a block diagram of components of a computing system in accordance with an embodiment of the present invention.

### DETAILED DESCRIPTION

Matching records and combining/appending features across different data sources can prove complex. This problem is typically referred to as entity resolution, and is central to data integration and merging. Feature engineering can provide insights to data scientists and engineers, but such insights are not necessarily provided without delaying model training. Sometimes, an initial dataset utilized in training a machine learning model may require additional datapoints or features to perform better. Similar data processing from different crowd sourced datasets and subsequent assessments of whether merging such data to the initial dataset improves performance may additionally delay model training. Similar features may be obtained by continuously comparing delta variations in model performance metrics. For example, one dataset may refer to population by zip code, while other datasets may refer to populations by county. Merging two such databases may not necessarily improve performance of a model trained on the combined datasets. Merging similar features in a dynamic fashion to create a fair model can lead to difficulties in dynamic performance metrics assessment resultant from the merged data.

Embodiments of the present invention include a cognitive advisor agent configured to extract feature data and evaluate dataset type in order to classify data into categories based on their pertinence to time series, classification, and regression models. The cognitive advisor agent may additionally be configured to categorize data into unstructured text features and categorical features, and may additionally find similar features from crowd sourced datasets. Unstructured text features may include written content that lacks metadata and therefore cannot be readily indexed or mapped onto standard database fields. Comparatively, categorical features correspond to features which are defined by corresponding metadata, and which correspond to categorical variables which may take on one of a limited, and usually fixed, number of possible values. The cognitive advisor agent may additionally use reinforcement learning to append new features to the existing dataset, and may subsequently reassess the model for its performance. Embodiments of the present invention focus on type of entity as an instructive element for using different algorithms to identify similar features. Embodiments of the present invention focus on reinforcement learning to compare the delta variation in model performance metrics.

Generally, the concept of “feature similarity” between two features as discussed herein describes a level to which said two features correspond to a same (or similar) concept. For example, multiple different datasets indicating test results across various geographies may include data features corresponding to the test results as well as defining characteristics of each set of results in the form of data features such as dates, holidays, states, counties, cities, etc. In such a case, a high similarity may be observed between the date feature and the holiday feature since they are both features which correspond to a temporal indication (i.e., when did something happen). Similarly, there may be a high similarity observed between the state, county, and city features, since they are all features which correspond to a geographical indication (i.e., where did something).

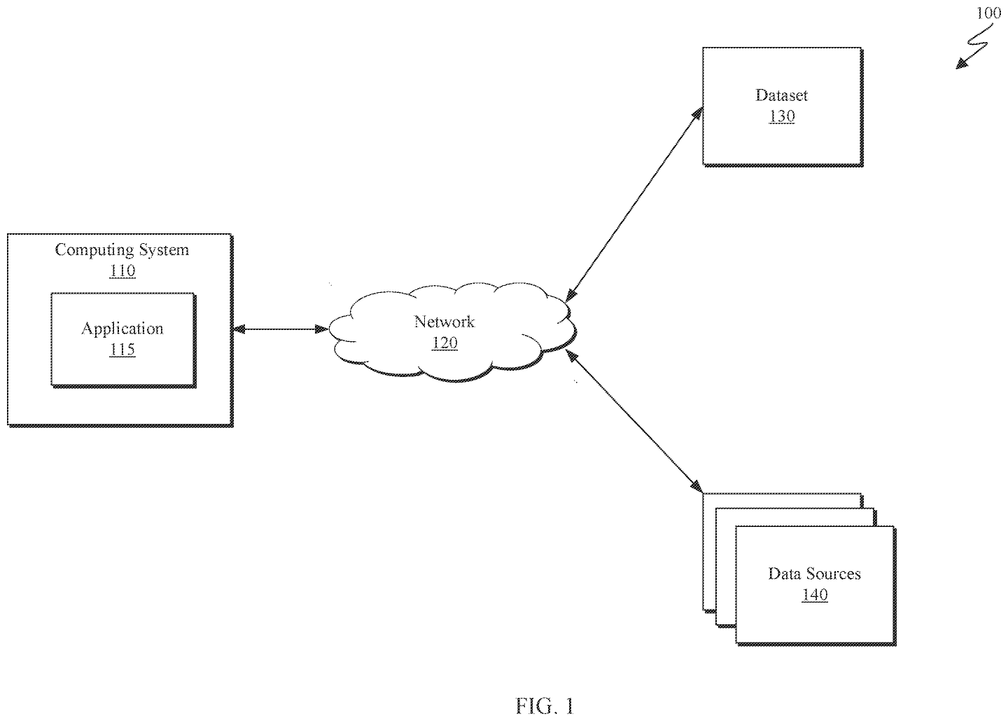

FIG. 1 is a block diagram depicting a cognitive advising system 100 in accordance with at least one embodiment of the present invention. As depicted, cognitive advising system 100 includes computing system 110, network 120, dataset 130, and crowdsourced dataset(s) 140. Cognitive advising system 100 may enable identifying similar features in various datasets and merging datasets accordingly. FIG. 1 provides only an illustration of one implementation and does not imply any limitations regarding the environments in which different embodiments may be implemented. Many modifications to the depicted environment may be made by those skilled in the art without departing from the scope of the invention as recited by the claims.

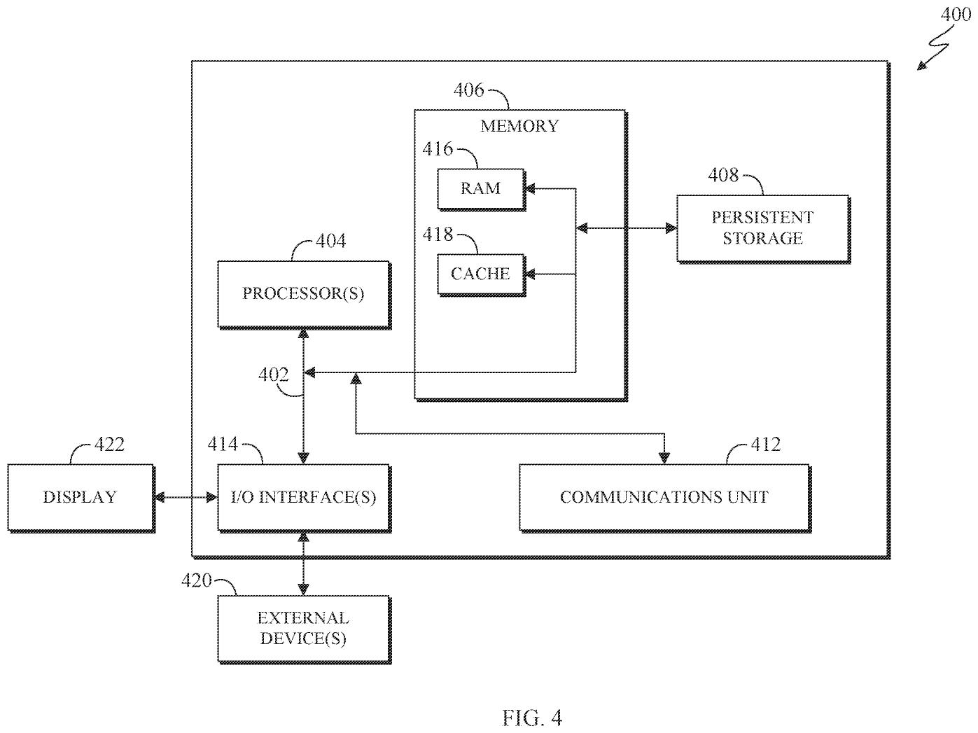

Computing system 110 can be a desktop computer, a laptop computer, a specialized computer server, or any other computer system known in the art. In some embodiments, computer system 110 represents a computer system utilizing clustered computers to act as a single pool of seamless resources. In general, computing system 110 is representative of any electronic device, or combination of electronic devices, capable of receiving and transmitting data, as described in greater detail with regard to FIG. 4. Computing system 110 may include internal and external hardware components, as depicted and described in further detail with respect to FIG. 4.

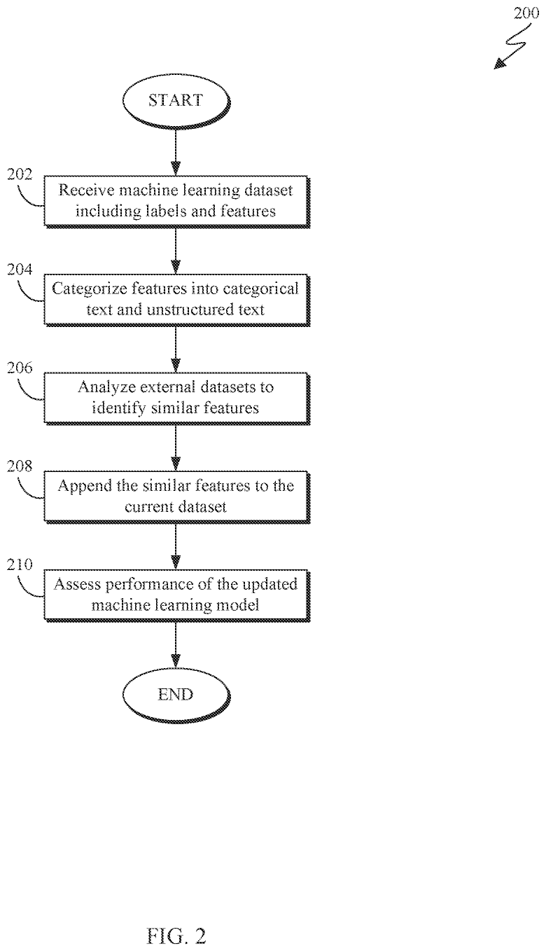

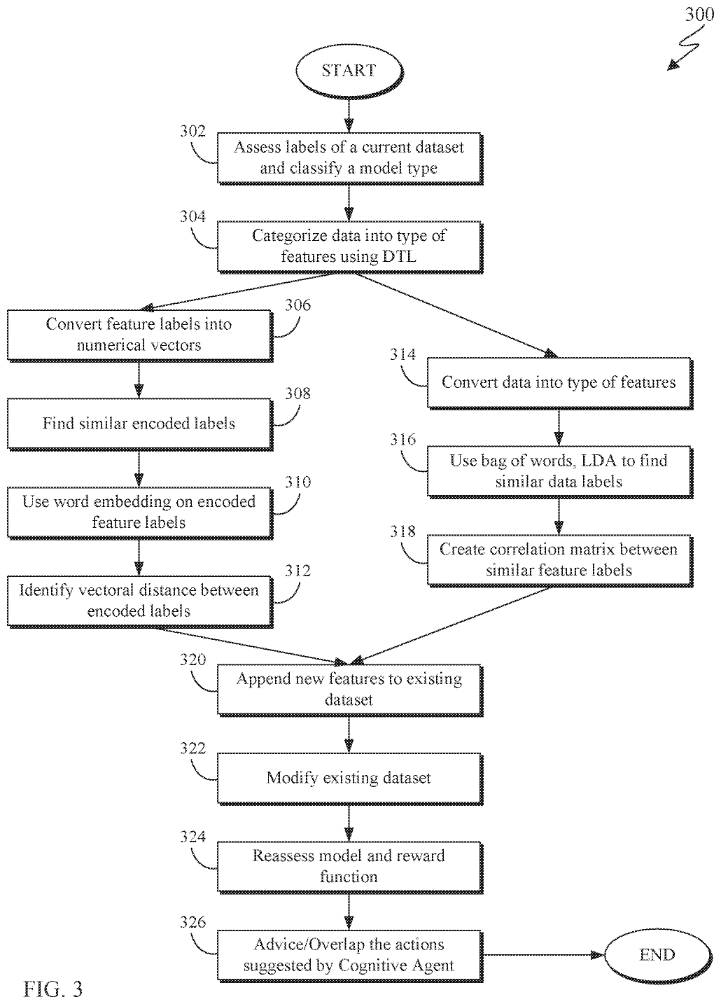

As depicted, computing system 110 includes application 115. Application 115 may be configured to execute a model updating method, such as model updating method 200 described with respect to FIG. 2. Application 115 may be configured to execute a cognitive advising method, such as cognitive advising method 300 described with respect to FIG. 3. In general, application 115 is configured to communicate with dataset 130 and crowdsourced dataset(s) 140 via network 120. In at least some embodiments, application 115 is configured to analyze dataset 130 to identify features and feature labels within dataset 130. Application 115 may be configured to query crowdsourced dataset(s) 140 for features and/or labels similar to the features and/or labels present within dataset 130. While the depicted embodiment shows application 115 hosted separately from dataset 130, it should be appreciated that in other embodiments, application 115 and dataset 130 may be collocated on a single system. In at least some embodiments, application 115 may be referred to as a cognitive advising agent.

Network 120 can be, for example, a local area network (LAN), a wide area network (WAN) such as the Internet, or a combination of the two, and include wired, wireless, or fiber optics connections. In general, network 120 can be any combination of connections and protocols that will support communications between any of computing system 110, application 115, dataset 130, and data sources 140.

Dataset 130 may be a dataset comprising one or more features and one or more corresponding feature labels. In at least some embodiments, dataset 130 additionally includes a feature importance metric indicating how important each feature of the dataset is. In general, dataset 130 is an arrangement of data accessible by computing system 110 and application 115. Dataset 130 may be stored in a data source configured to store received information, such as a database that gives permissioned access to computing system 110. In at least some embodiments, dataset 130 is stored in a publicly available database accessible by computing system 110. In general, dataset 130 is available on a data source implemented using any non-volatile storage media known in the art, such as a tape library, optical library, one or more independent hard disk drives, or multiple hard disk drives in a redundant array of independent disk (RAID).

Data sources 140 may be configured to store received information and can be representative of one or more databases that give permissioned access to computing system 110. In at least some embodiments, data sources 140 are representative of publicly available databases accessible by computing system 110. In general, data sources 140 can be implemented using any non-volatile storage media known in the art. For example, data sources 140 can be implemented with a tape library, optical library, one or more independent hard disk drives, or multiple hard disk drives in a redundant array of independent disk (RAID). In general, data sources 140 are configured to receive queries from computing system 110 or application 115 requesting features or feature labels similar to features or feature labels present within dataset 130.

FIG. 2 is a flowchart depicting a model updating method 200 in accordance with an embodiment of the present invention. As depicted, model updating method 200 includes receiving (202) a machine learning dataset including labels and features, categorizing (204) the features into categorical text features and unstructured text features, analyzing (206) external datasets to identify similar features, appending (208) the similar features to the current dataset, and assessing (210) performance of a machine learning model in light of the appended dataset. FIG. 2 depicts some operational procedures of application 115 in FIG. 1.

Receiving (202) a machine learning dataset including labels and features may include identifying a dataset corresponding to a machine learning model of interest. As used herein “labels” correspond to text descriptions metadata indicating a feature, and in many cases, the two terms may be used interchangeably. Generally, labels may be descriptions or headings utilized to colloquially identify features, but with respect to the embodiments disclosed, labels are used simply to identify features themselves. In at least some embodiments, receiving (202) a machine learning dataset including labels and features additional includes receiving feature importance corresponding to each of the received features. Receiving (202) a machine learning dataset may additionally include receiving a machine learning model trained according to the received machine learning dataset.

Categorizing (204) the features into categorical text features and unstructured text features may include categorizing the labels of the current dataset to determine whether the feature labels fall into categorical feature data or unstructured text data. In at least some embodiments, categorizing (204) the features includes using diode-transistor logic (DTL) to classify feature labels into categorical feature data or unstructured text data. In general, categorizing (204) the features into categorical text features and unstructured text features includes separating the features based on whether the features have

Analyzing (206) external datasets to identify similar features may include querying one or more external data sources for datasets including similar labels and/or similar features. In at least some embodiments, analyzing (206) external datasets to identify similar features includes comparing the features as they appear originally in the dataset to features in other external datasets; in other embodiments, analyzing (206) external datasets to identify similar features includes first converting the features of the initial dataset into numerical vector form, and then comparing said vector form to vectorized versions of the features present in available external datasets. Analyzing (206) external datasets to identify similar features may include searching for both unstructured data and categorical feature data corresponding to similar features.

Appending (208) the similar features to the current dataset may include adding the features identified as similar to the existing features to the current dataset. In at least some embodiments, appending (208) the similar features to the current dataset includes adding features whose similarity exceeds a threshold to the current dataset. In other embodiments, such as embodiments where it is desirable to add features which are distinct from those features already present in the dataset, appending (320) new features to the current dataset includes adding features whose similarity falls below a threshold amount to the current dataset. Appending (208) the similar features to the current dataset may additionally include amending the dataset version and updating additional instances of the current dataset to reflect the appended new features. Appending (208) the similar features to the current dataset includes amending the dataset to include features identified as similar to the categorical feature data as well as the features identified as similar to the unstructured text data.

Assessing (210) performance of a machine learning model in light of the appended dataset may include conducting performance analytics to analyze the performance of the machine learning model in light of the updated dataset (wherein the updated dataset is the initial dataset subsequent to the additions of the appended similar features). In at least some embodiments, assessing (210) performance of the machine learning model in light of the appended dataset includes training the machine learning model on the updated dataset. Assessing (210) performance of the machine learning model may further include comparing the performance of the machine learning model after it has been trained on the updated dataset to the performance prior to said training. Specific mechanisms for assessing model performance are discussed in greater detail with respect to step 324 of cognitive advising method 300 and FIG. 3.

FIG. 3 is a flowchart depicting a cognitive advising method 300 in accordance with an embodiment of the present invention. As depicted, cognitive advising method 300 includes assessing (302) labels of a current dataset and classifying a model type, categorizing (304) data into feature types, converting (306) feature labels into numerical vectors, finding (308) similar encoded labels, using (310) word embedding on encoded feature labels, identifying (312) vectoral distance between encoded labels, converting (314) data into feature types, finding (316) similar encoded labels, creating (318) a correlation matrix between similar feature labels, appending (320) new features to an existing dataset, modifying (322) the existing dataset, reassessing (324) a model and reward function, and advising (326) the actions suggested by cognitive agent. FIG. 3 depicts some operational procedures of application 115 in FIG. 1.

Assessing (302) labels of a current dataset and identifying a corresponding model type may include receiving a current dataset and evaluating features of the dataset. Assessing (302) labels of the current dataset may include inspecting backend elements of the feature labels to identify feature label priorities and feature label correlations to one another. Assessing (302) labels of a current dataset may further include identifying a model appropriate to model the target feature of the current model by determining if the target feature corresponds to classification, regression, or time series. Classifying the corresponding model type provides insights regarding how finding similar features from different data sets would influence features of the current dataset. Assessing (302) labels of a current dataset and classifying the corresponding model type may include leveraging existing automated machine learning techniques. In some cases, a trained model is already available, in which case current model analysis is unnecessary.

Categorizing (304) data into feature types may include categorizing the labels of the current dataset to determine whether the feature labels fall into categorical feature data or unstructured text data. In at least some embodiments, categorizing (304) data includes using diode-transistor logic (DTL) to classify feature labels into categorical feature data or unstructured text data. For feature labels which are categorical in nature, the method continues by converting (306) feature labels into numerical vectors. For feature labels which are unstructured text, the method continues by converting (314) data into feature types or feature labels. Feature types as used in this context may include keywords in the unstructured text which may indicate or correspond to feature labels as present with respect to the metadata accompanying the categorical features. Converting (314) the unstructured text data into feature types may include using natural language processing techniques to extract feature information (such as feature types or feature labels) from the unstructured text information.

Converting (306) feature labels into numerical vectors may include utilizing any known natural language processing technique or techniques known in the art to convert feature labels into vector format. In at least some embodiments, converting (306) feature labels into numerical vectors occurs simultaneously with finding (308) similar encoded labels.

Finding (308) similar encoded labels may include querying one or more crowd-sourced datasets for encoded labels which are similar to the feature labels which have been categorized as categorical feature data. In at least one embodiment, finding (308) similar encoded labels includes searching datasets resultant from the query (or queries) for labels which are similar to the feature labels. In general, using (310) word embedding on encoded feature labels includes representing words for text analysis in the form of a real-valued vector that encodes the meaning of the word such that the words that are closer in the vector space are expected to be similar in meaning.

Identifying (312) vectoral distance between encoded labels may include analyzing the labels of the current dataset and the similar encoded labels and identifying their respective vectoral positions. Identifying (312) vectoral distance between encoded labels may include determining a distance between the vector positions of the labels. In at least some embodiments, identifying (312) vectoral distance between encoded labels includes using cosine similarity to determine the vectoral distance.

Converting (314) data into feature types may include, for data categorized as unstructured text data, identifying one or more feature labels indicated by the data. In at least some embodiments, converting (314) data into feature types for unstructured text data may include leveraging named-entity recognition (NER) techniques to convert the data. NER (also called named entity identification, entity chunking, and entity extraction) is a subtask of information extraction that seeks to locate and classify named entities mentioned in unstructured text into pre-defined categories such as person names, organizations, locations, medical codes, time expressions, quantities, monetary values, percentages, etc. These pre-defined categories may be curated to include categories specific to the machine learning model of interest. In at least some embodiments, converting (314) data into feature types for unstructured text data may include using word embedding techniques to represent words for text analysis in the form of a real-valued vector that encodes the meaning of the word. Converting (314) data into feature types for unstructured text data may include leveraging topic modeling using Latent Dirichlet Allocation (LDA) methodologies to represent the data. LDA models represent documents as mixtures of topics that yield words with associated probabilities based on the mixtures of topics.

Finding (316) similar encoded labels may include leveraging bag of words modeling to find similar data labels from crowd sourced datasets. The bag of words model is a simplifying representation in which a text is represented as a “bag” (or multiset) of its words. In at least some embodiments, finding (316) similar encoded labels occurs according to encoded label values, such that similar encoded labels have similar encoded values.

Creating (318) a correlation matrix between similar feature labels includes creating a matrix indicating levels of similarity between the feature labels. In at least some embodiments, creating (318) a correlation matrix includes using cosine similarity on the vectorized text data to create the values for the correlation matrix. The resultant matrix indicates a pool of similar features/feature labels that can be merged in the current dataset. In at least some embodiments, creating (318) a correlation matrix between similar feature labels includes using Pearson correlation to create the correlation matrix values.

While the depicted embodiment includes identifying vectoral distances with respect to categorical data (step 312) and creating a correlation matrix between similar labels with respect to unstructured text data (step 318), there may exist other embodiments wherein identifying vectoral differences is an appropriate similarity comparison for both categorical data and unstructured text data. Similarly, there may exist yet other embodiments wherein creating a correlation matrix between similar feature labels is an appropriate similarity comparison for both categorical data and unstructured text data. Therefore, it should be appreciated that the depicted embodiment corresponds to but one implementation of the described comparison techniques and is not intended to be limiting in that regard.

Appending (320) new features to the current dataset may include adding the features identified as similar to the existing features to the current dataset. In at least some embodiments, appending (320) new features to the current dataset includes adding features whose similarity exceeds a threshold to the current dataset. In other embodiments, such as embodiments where it is desirable to add features which are distinct from those features already present in the dataset, appending (320) new features to the current dataset includes adding features whose similarity falls below a threshold amount to the current dataset.

Modifying (322) the current dataset may include modifying a dataset/model version number to reflect that a new version has been created. In at least some embodiments, modifying (322) the existing dataset occurs responsive to appending (320) new features to the current dataset. In general, modifying (322) the current dataset includes amending the dataset version and updating additional instances of the current dataset to reflect the appended new features.

Reassessing (324) model performance may include applying the modified dataset to the model and determining the impact that appending similar features to the dataset has on the performance of the model. In at least some embodiments, reassessing (324) model performance includes training the model according to the modified dataset. Reassessing (324) model performance may include comparing the performance of the model after it has been trained using the modified dataset to its performance previous to said training. In at least some embodiments, reassessing (324) model performance includes monitoring one or more performance metrics of interest. In at least some embodiments, performance metrics of interest may include model quality metrics such as model accuracy, ROC-AUC Score, F1 score, minimal cost/loss function value, etc. Reassessing (324) model performance may include identifying a set of actions A taken to determine whether to optimize the dataset by merging or modifying the existing features. In at least some embodiments, reassessing (324) model performance includes identifying a set of states S which are indicative of the states of a set of parameters both before and after the set of actions A are taken at a time/instant T. States S, actions A, and time T are parameters which may be utilized by a reinforcement learning (RL) model. The RL model analyzes how the model is performing as the parameters change. If the performance is not optimal, or is diminishing, the RL model will reflect these conditions, and can reveal which changes to the parameters lead to the suboptimal performance. Accordingly, the RL model can lead to automated recommendations for additional actions to improve the performance. Reassessing (324) model performance may additionally include assessing a reward function's performance. The reward function R is directly proportional to the model versioned outcome in terms of delta of the performance metric. In at least some embodiments, R is calculated according to the following:

R=k*f(updated_model_score−previous_model_score)

With respect to the above equation, k represents a scaling constant such that R is proportional to the function ƒ. Function ƒ indicates a log or sigmoid function depending on whether the model is a classification model or a regression model. In at least some embodiments, if the R value is negative, then the updated model is not performing better than the previous model without feature modification.

Advising (326) one or more actions may include determining which actions from the set of actions A lead to a positive/desirable change in states S. In at least some embodiments, advising (326) one or more actions includes advising keeping one or more of the appended new features in the dataset. Advising (326) one or more actions may include advising that one or more of the appended new features in the dataset should be extracted. In at least some embodiments, advising (326) one or more actions may include advising that the dataset should be reverted to its prior state (previous to the addition of the new features). In at least some embodiments, Q learning is used as a value-based method of supplying information to inform which action should be taken to modify the reward function. Advising (326) one or more actions may include recommending the existing dataset be modified to negate some bad or biased data, or to better balance the data in the dataset.

Consider a scenario in which a client is working on multiple machine learning models with initial features f₁, f₂, f₃, and f₄ and corresponding feature weights w₁, w₂, w₃, and w₄. The system is scraping data in the background and identifies a new feature f₅ with a potentially confusing data label. Responsive to the identification of the new feature, feature f₅ and its corresponding label are subjected to data classification by computing a Euclidian distance between the values associated with a previous feature, such as f₄, and the new feature f₅. The computed Euclidian distances are then fed into a correlation matrix. Assume the correlation is determined to be negative; the feature is therefore added (and ignored if the model assessment doesn't vary and the features were closely correlated). Next, the feature is appended to the model, the previous weights w₁-w₄ are maintained, while w₅ corresponding to feature f₅ is initialized with a randomization function. The updated weights resultant from the randomization function are computed and fed into the state of a reinforcement learning model, wherein state goes from S₁ to S₂; state S₂ in this case would correspond to a minor change in weights and the addition of f₅ to the model relative to state S₁. If the model does not improve utilizing the conditions of state S₂, the weights may undergo additional trimming epochs and backpropagation to yield further updated weights. In case the model parameters are not evaluating the model output, the features (which are partly tied to one another) are fed into a data transformation function wherein f₄ gets multiplied by f₅ (i.e., f₄*f₅ is the data transformation step) to create a pipeline of the model. Another pipeline of the model may be created by dividing f₄ by f₅ based on data classification. Eventually, a state S₃ of the reinforcement learning model is reached wherein the model is yielding improved results, such that the output of said model showcases the improved model assessment.

FIG. 4 depicts a block diagram of components of computing system 110 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications, and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method comprising:
receiving a dataset for use with respect to a current machine learning model, wherein the dataset comprises one or more features;
analyzing one or more external datasets to identify a set of similar features;
appending the set of similar features to the received dataset to generate an updated dataset;
applying the updated dataset to the current machine learning model to generate an updated machine learning model; and
assessing performance of the updated machine learning model.

2. The computer implemented method of claim 1, further comprising recommending one or more actions based on the performance assessment of the updated machine learning model.

3. The computer implemented method of claim 1, wherein analyzing one or more external datasets to identify a set of similar features includes:
converting the one or more features into numerical feature vectors;
identifying a set of similar features in the one or more external datasets;
using word embedding on the set of similar features; and
identifying a vectoral distance between the one or more features and the set of similar features.

4. The computer implemented method of claim 1, wherein the current machine learning model includes a reinforcement learning model.

5. The computer implemented method of claim 1, wherein analyzing one or more external datasets to identify a set of similar features includes using a bag of words technique to find similar features.

6. The computer implemented method of claim 1, further comprising using Pearson correlation to create a correlation between the one or more features and the set of similar features indicating a level of similarity.

7. The computer implemented method of claim 1, further comprising categorizing the features of the dataset into categorical features and unstructured text features, wherein categorical features are features with corresponding identifying metadata, and unstructured text features are features which lack such metadata.

8. A computer program product comprising:
one or more computer readable storage media and program instructions stored on the one or more computer readable storage media, the program instructions comprising instructions to:
receive a dataset for use with respect to a current machine learning model, wherein the dataset comprises one or more features;
analyze one or more external datasets to identify a set of similar features;
append the set of similar features to the received dataset to generate an updated dataset;
apply the updated dataset to the current machine learning model to generate an updated machine learning model; and
assess performance of the updated machine learning model.

9. The computer program product of claim 8, the program instructions further comprising instructions to recommend one or more actions based on the performance assessment of the updated machine learning model.

10. The computer program product of claim 8, wherein the program instructions to analyze one or more external datasets to identify a set of similar features comprise instructions to:
convert the one or more features into numerical feature vectors;
identify a set of similar features in the one or more external datasets;
use word embedding on the set of similar features; and
identify a vectoral distance between the one or more features and the set of similar features.

11. The computer program product of claim 8, wherein the current machine learning model includes a reinforcement learning model.

12. The computer program product of claim 8, wherein the program instructions to analyze one or more external datasets to identify a set of similar features comprise instructions to use a bag of words technique to find similar features.

13. The computer program product of claim 8, the program instructions further comprising instructions to use Pearson correlation to create a correlation between the one or more features and the set of similar features indicating a level of similarity.

14. The computer program product of claim 8, wherein the program instructions further comprise instructions to categorize the features of the dataset into categorical text features and unstructured text features, wherein categorical features are features with corresponding identifying metadata, and unstructured text features are features which lack such metadata.

15. A computer system comprising:
one or more computer processors;
one or more computer-readable storage media;
program instructions stored on the computer-readable storage media for execution by at least one of the one or more processors, the program instructions comprising instructions to:
receive a dataset for use with respect to a current machine learning model, wherein the dataset comprises one or more features;
analyze one or more external datasets to identify a set of similar features;
append the set of similar features to the received dataset to generate an updated dataset;
apply the updated dataset to the current machine learning model to generate an updated machine learning model; and
assess performance of the updated machine learning model.

16. The computer system of claim 15, the program instructions further comprising instructions to recommend one or more actions based on the performance assessment of the updated machine learning model.

17. The computer system of claim 15, wherein the program instructions to analyze one or more external datasets to identify a set of similar features comprise instructions to:
convert the one or more features into numerical feature vectors;
identify a set of similar features in the one or more external datasets;
use word embedding on the set of similar features; and
identify a vectoral distance between the one or more features and the set of similar features.

18. The computer system of claim 15, wherein the current machine learning model includes a reinforcement learning model.

19. The computer system of claim 15, wherein the program instructions to analyze one or more external datasets to identify a set of similar features comprise instructions to use a bag of words technique to find similar features.

20. The computer system of claim 15, the program instructions further comprising instructions to use Pearson correlation to create a correlation between the one or more features and the set of similar features indicating a level of similarity.
